(19) United States
(12) Patent Application Publication
(10) Pub. No.: US 2007/0036603 A1
(43) Pub. Date: Feb. 15, 2007

(54) Portable keyboard

(76) Inventor: Marek Swoboda, Philadephia, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 10/572,896

(22) PCT Filed: Sep. 22, 2004
(86) PCT No.: PCT/US04/30948

§ 371 Date: Mar. 21, 2006

Related U.S. Application Data
(60) Provisional application No. 60/504,686, filed on Sep. 22, 2003.

(51) Int. Cl. B41J 5/00

(52) U.S. Cl. 400/472

(57) ABSTRACT

A keyboard for an electronic device comprises a housing having a top portion, a bottom portion, a first side portion and a second side portion. A plurality of keys are activatable from the bottom portion of the housing and optional keys may be activatable from either or both side portions of the housing. A mechanism indicates the character or function of the plurality of keys activatable from the bottom portion of the housing.

### CROSS-REFERENCE TO RELATED APPLICATION

This application claims the benefit of U.S. Provisional Application No. 60/504,686, filed Sep. 22, 2003, the entire disclosure of which is incorporated herein by reference.

### FIELD

This invention relates to electronic input devices. More particularly, the present invention is directed to keyboards.

### BACKGROUND

Existing computer keyboards generally are not comfortable. They tend to be bulky (usually ˜18″ by ˜6″) and require some kind of physical support to type. One has to put it on a desk or place it on some other type of physical support, such as one's lap. It is generally difficult to move freely while typing, because the keyboard needs to be placed on a firm surface. Any change of the typist body position often requires repositioning the keyboard which often means finding a new support. Generally, typing while standing or walking is not feasible. Many existing keyboard designs further limit the user to a small number of body positions which may result in discomfort and generate health problems such as musculoskeletal diseases (e.g., scoliosis and other orthopedic diseases).

Typically, the keyboards that are part of a laptop or notebook require the typist's palms to be in an uncomfortable, unnaturally rotated position (which may result in Carpal Tunnel Syndrome). In addition, if the laptop sits on a table, such as in a cafeteria or a conference room, the palms and hands are slightly too high; if one puts the laptop on one's laps, one's palms are too low and more rotated.

The growth of personal digital assistants (PDAs) in the marketplace resulted in increased demand for small, portable keyboards. Two types of keyboards have been used with PDAs: standalone, miniaturized and often-folding traditional computer keyboards; and miniature keyboards attached to a PDA unit. The first category has the disadvantages described above, while the miniature keyboards attached to the PDA unit are generally too small to enable the user to fully use his ten fingers. The miniature keyboards usually require one finger (thumb) typing.

Another problem, generally common for existing keyboards is visibility of the keys. The typist's palms and fingers restrict the field of view. If the typist needs to see the keyboard, for example a non-touch typist, he has to move his fingers back and forth to determine which key to press.

### SUMMARY

A keyboard for an electronic device comprises a housing having a top portion, a bottom portion, a first side portion and a second side portion. A plurality of keys are activatable via the bottom portion of the housing and a mechanism indicates the character or function of the plurality of keys.

### BRIEF DESCRIPTION OF THE DRAWINGS

In the drawings, which are discussed below, one or more preferred embodiments are illustrated, with the same reference numerals referring to the same pieces of the invention throughout the drawings. It is understood that the invention is not limited to the preferred embodiments depicted in the drawings herein, but rather it is defined by the claims appended hereto and equivalent structures.

FIG. 1 is a front view of the keyboard of the present invention.

FIG. 2 is a side view of the keyboard of FIG. 1.

FIG. 3 is an exploded view of the keyboard in accordance with another embodiment of the invention.

FIG. 4 is another embodiment of the keyboard in accordance with the invention.

FIG. 5 is another embodiment of the keyboard in accordance with the invention.

FIG. 6 is another embodiment of a keyboard in accordance with the invention.

FIG. 7 is another embodiment of a keyboard in accordance with the invention.

FIG. 8 is another embodiment of a keyboard in accordance with the invention.

### DETAILED DESCRIPTION

While the specification concludes with claims particularly pointing out and distinctly claiming the subject matter that is regarded as the invention, the invention will now be further described by reference to the following detailed description of preferred embodiments taken in conjunction with the above-described accompanying drawings.

The present invention comprises a keyboard for an electronic device. Electronic devices include, but are not limited to, computers, PDAs, and cellular phones. The keyboard can incorporate any of the features of other electronic input devices currently known or created in the future, including, but not limited to, touchpads and joysticks.

The keyboards described herein are of a shape that permits the user to hold it in a natural, ergonomic position. The ergonomic position reduces the risks of Carpal Tunnel Syndrome when typing. In addition, the keys may be ergonomically positioned.

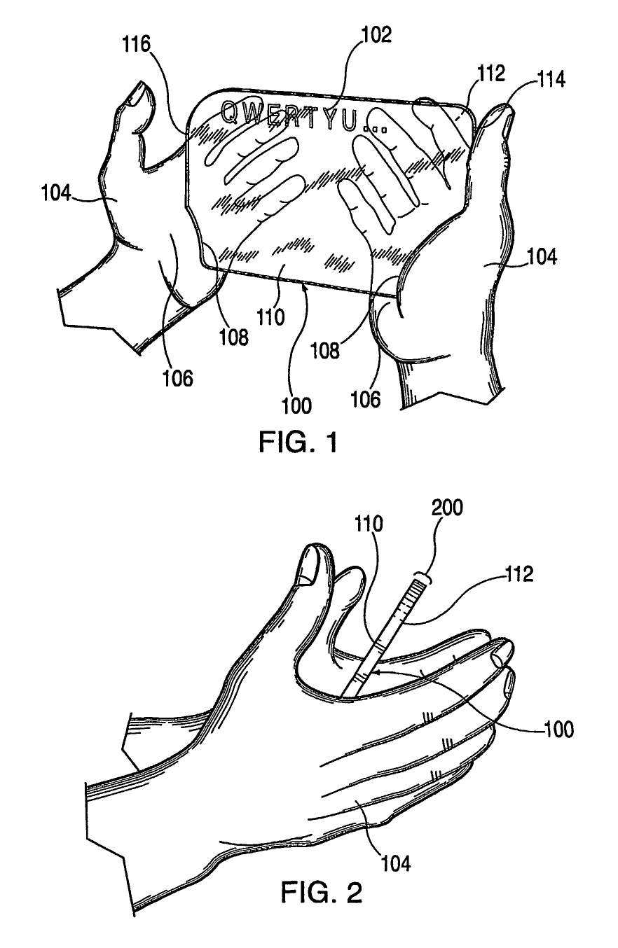

As shown in FIG. 1, a keyboard 100 comprises a housing having a top portion 110, a bottom portion 112, a first side portion 114 and a second side portion 116. The first side portion 114 and second side portion 116 are mirror images of each other; however, the side portions 114, 116 may be manufactured so that they are different from one another.

Although the keyboard 100 may be made to any size specification, the keyboard 100 in FIG. 1 is of a size capable of being held in a user's hands 104. The keyboard 100 rests in a user's palms 106. By having the side portions 114, 116 curved or molded 108 in such a way so that it substantially conforms to the curves in a user's palms 106, 106, the keyboard 100 rests on the user's palms 104 and does not need to be squeezed or gripped.

FIG. 2 shows a side view of the keyboard 100. The depth or thickness 200 of the housing may be as thin or as thick as the manufacturer desires. It is recommended that the thickness be one which does not provide discomfort to a user.

Returning to FIG. 1, keys 102 are activatable from the bottom portion 112 of the keyboard 100. The keys 102 can be of any layout desired by the manufacturer and/or user. The keys 102 may made of transparent, semi-transparent or opaque material or a combination of the foregoing. In FIG. 1, the keys 102 conform to the QWERTY layout, which is a layout well-known by the general public. At least one key may be located on at least one side portion 114, 116 so that the user may activate the key with his thumb. For example, when utilizing a QWERTY layout, the shift, tab and the spacebar keys may be located on one or both of the sides of the keyboard 114, 116; alternatively, only some of these keys may be found on one side and the other keys may be found on the other side.

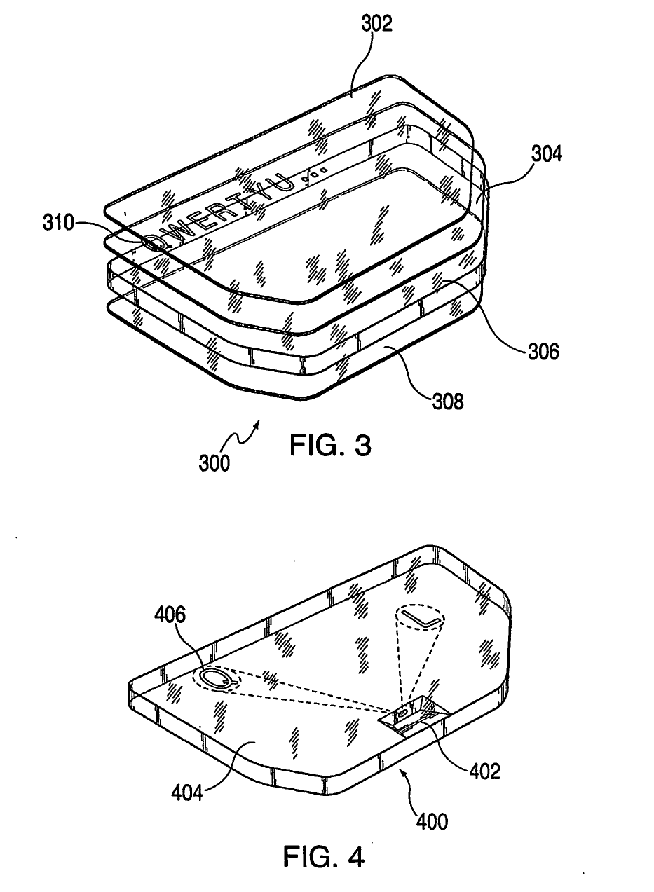

In one embodiment, depicted in FIG. 3, the keyboard 300 is made of four layers 302, 304, 306, 308. The top layer 302 is a transparent touch screen. The second layer 304 is a transparent monitor or like device. The third layer 306 is a transparent board or like material and the fourth layer 308 is also a transparent touch screen. The images, icons or characters of the keys 310 are found on the transparent layer 310 as the keys 310 may be transparent, semi-transparent or opaque. Alternatively, the images, icons or characters of the keys 310 can be printed on any or all of the layers 302, 304, 303, 306, 308. Printing the images, icons or characters of the keys can be performed by silk screening or any other method of printing known by those skilled in the art. Or, the images, icons or characters of the keys can be projected via the transparent monitor or like device 304.

Another version of the keyboard is found in FIG. 4. In this figure, keyboard 400 is equipped with an image projecting device 402, such as a light emitting diode (LED), laser projector or like device, which is operably connected to a transparent board 404. The image projecting device 402 projects images of the keys 406 so that a user looking down at the top portion of the housing sees the character or function of the keys. Alternatively, the image projecting device 402 can be operably connected anywhere to the housing so long as it projects an image viewable to the user.

Optionally, when the characters or icons of the keys 402 are projected, the transparent board also may be used to project pictures, graphs, spreadsheets, documents, etc. which can be activated or controlled by a button, switch or like element operably connected to the keyboard 400.

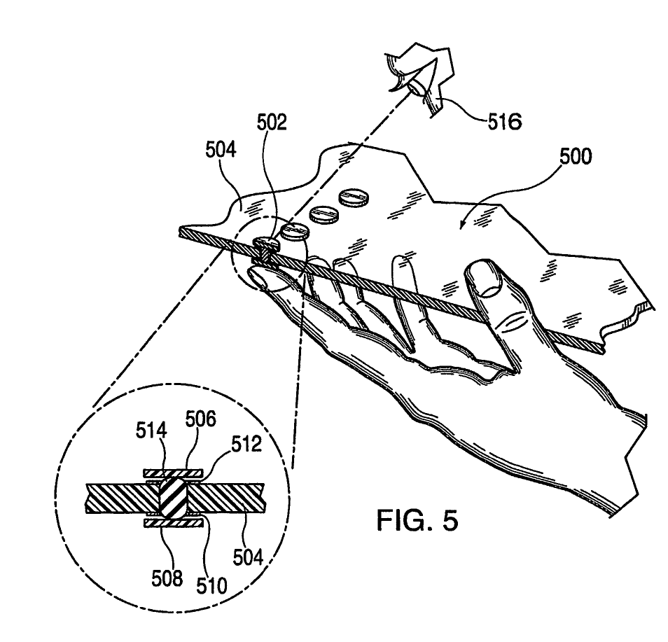

Mechanical keys may also be utilized with the keyboard. FIG. 5 shows one embodiment of the keyboard utilizing mechanical keys. The keyboard 500 utilizes mechanical keys 502 that are operably connected to a transparent board 504. The mechanical keys 502 are two-sided switch activated keys that can be activated from the top 506 and bottom 508. The switch is electrically connected 512 with the keyboard/input controller. An elastic element 514 may be present to position the switch in a neutral position when not being activated by a user 516. In an alternative embodiment, the mechanical keys are one-side switch activated keys that can be activated from the bottom of the keyboard.

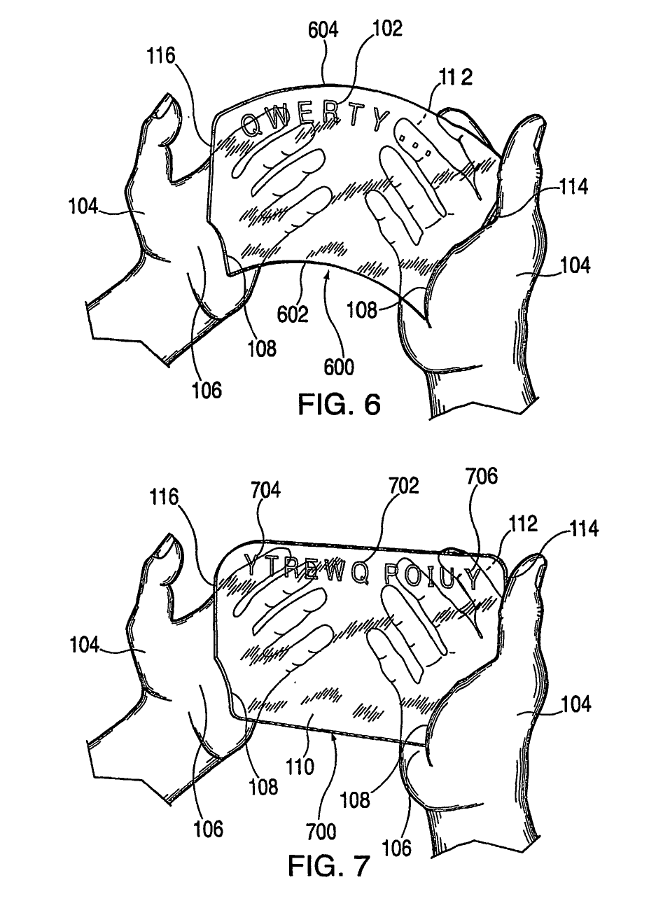

Yet another embodiment of the invention is shown in FIG. 6. The keyboard 600 contains the same features as FIG. 1 with the addition of a curved housing 602, 604. The curvatures 602, 604 enable the user's palms to be in an even more ergonomic position.

Still yet another embodiment is shown in FIG. 7. FIG. 7 contains the same features as FIG. 1, but has a different key layout. The keys 702 are positioned so that a user will not need to learn the positions of the keys 702 when the user is accustomed to typing on a conventional keyboard. As shown in the figure, the keys 702 are located so that the user will use the same fingers to activate the keys 702 as if he were using a conventional keyboard. The “Q” key is located in a position so that the user's pinkie finger can be used to activate it. The “Y” key may be located so that either one or both of the user's index fingers can activate it. For example, FIG. 7 shows the “Y” key being located in two positions 704, 706, but the keyboard 700 may be produced so that the “Y” key is located in only one position 704 or 706.

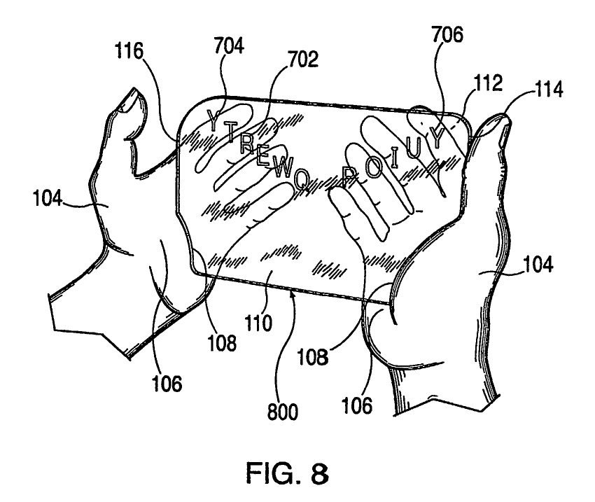

FIG. 8 shows another embodiment of the keyboard. FIG. 8 contains the same features of FIG. 7, with the addition of being more ergonomic. The keyboard 800 has the keys 702 located in ergonomic positions. The use of ergonomic positions for the keys may be utilized in any embodiment of the keyboards described herein, including, but not limited to, those using QWERTY and non-QWERTY layouts.

Although now described with respect to FIG. 1, the following description also applies to the various embodiments of the keyboards described above.

The user places the keyboard 100 between his hands 104 so that the side portions 114, 116 rest in the curvature of his palms 106. In the typical mode of operation, the user clearly sees the icons, images or characters of the keys and the keyboard at all times because his hands are behind the keyboard. Although not shown, the keyboard 100 has optional keys located on the side portions 114, 116 so that the user can activate them with his thumbs.

The keyboard 100 is made of any suitable rigid, substantially rigid or semi-rigid material(s) or combinations thereof. In one embodiment, the keyboard 100 is transparent and the image or icon 102 of the character or function each key 102 represents can be seen when viewing the top portion 104 of the keyboard 100. The image or icon depicting what the keys 102 located on the sides represent may or may not be viewable when looking down at the keyboard 100.

Alternatively, the keyboard 100 maybe semi-transparent or opaque, or a combination of transparent, semi-transparent and/or opaque materials. Images or icons 102 are viewable from the top portion 104 corresponding to and representing the keys 102 found on the bottom portion of the keyboard 100. As with the transparent version of the keyboard, the manufacturer determines whether the keys, if any, located on the side portions 114, 116 have images associated therewith so that a user will be able to readily determine which key performs a specific function when looking at the top portion of the keyboard 100. A benefit of utilizing a material that permits the user to see his fingers activate the keys is that the user is likely to be more accurate when typing and is also likely to adapt to the new keyboard more quickly than if he could not see his fingers activate the keys.

The shape of keyboard 100 permits ten-finger typing when at least one key is found on both side portions 114, 116. It also allows the user to hold the keyboard 100 and not activate any of the keys 102 without specifically activating the key. Because of its compactness, the user can sit or use the keyboard 100 in virtually any position, including, but not limited to, sitting, standing and walking.

In yet another alternative embodiment (not shown), the keyboard has a support mechanism operably connected to the housing. One such support mechanism is legs. Legs are operably connected to the keyboard so that a user is able to place the keyboard on a flat surface. The legs may be of such a length so that when the legs are in contact with a flat surface, the user's fingers are able to be between the flat surface and the bottom portion of the keyboard. Optionally, top-activatable keys may be present so that the user can activate most or many of the keys from the top portion of the keyboard when the keyboard is placed on a flat surface. Another support mechanism that may be utilized is a harness. The harness may be any suitable device that permits the user to hold or carry the keyboard without requiring the use of his hands. Yet another support mechanism that may be utilized is a housing adapted to receive the keyboard so that the user does not need to hold the keyboard but is still able to activate the keys.

An optical sensor capable of locating a user's finger position on the keyboard surface may be utilized to activate the keys. Also, the keyboard may be manufactured so that its dimensions are adjustable, i.e., a user can make the keyboard wider or taller to better fit in his hand.

The keyboards described herein are electronically connected to an electronic device. This electrical connection may be wired, wireless, infrared or any other technology that permits electrical signals to be transmitted from one device to another.

The present invention may be embodied in other specific forms without departing from the spirit or essential attributes thereof and, accordingly, reference should be made to the appended claims, rather than to the foregoing specification, as indicating the scope of the invention.

What is claimed is:

1. A keyboard for an electronic device comprising:
a housing having a top portion, a bottom portion, a first side portion and a second side portion;
a plurality of keys activatable from the bottom portion of the housing;
a mechanism for indicating the character or function of the plurality of keys activatable from the bottom portion of the housing.

2. The keyboard of claim 1, wherein the plurality of keys follow a QWERTY keyboard layout.

3. The keyboard of claim 1, further comprising at least one key activatable from at least one side portion of the housing.

4. The keyboard of claim 1, wherein the housing is transparent.

5. The computer keyboard of claim 1, wherein the keys are transparent, semi-transparent, opaque or a combination thereof.

6. The keyboard of claim 1, further comprising a support mechanism operably connected to the housing.

7. The keyboard of claim 6, wherein the support mechanism comprises a harness.

8. The keyboard of claim 6, wherein the support mechanism comprises legs.

9. The keyboard of claim 1, wherein the keyboard is wirelessly connected to the electronic device.

10. The keyboard of claim 1, wherein the housing is contoured to rest on a user's palms.

11. The keyboard of claim 1, wherein the mechanism for indicating the character or function of the plurality of keys comprises an icon or projected image.

12. The keyboard of claim 1, wherein the plurality of keys are located in ergonomic positions.

13. A keyboard for an electronic device comprising:
a housing contoured to rest on a user's palms, the housing having a top portion, a bottom portion, a first side portion and a second side portion; and
a plurality of keys activatable from the bottom portion of the housing.

14. The keyboard of claim 13, further comprising at least one key activatable from at least one side portion of the housing.

15. The keyboard of claim 13, wherein the housing is transparent.

16. The keyboard of claim 13, further comprising a mechanism for indicating the character or function of the plurality of keys activatable from the bottom portion of the housing.

17. The keyboard of claim 16, wherein the mechanism for indicating the character or function of the plurality of keys comprises an icon or projected image.

18. The keyboard of claim 13, wherein the plurality of keys follow a QWERTY keyboard layout.

19. The keyboard of claim 13, wherein the plurality of keys are ergonomically positioned.

20. A keyboard for an electronic device comprising:
a housing contoured to rest on a user's palms, the housing having a top portion, a bottom portion, a first side portion and a second side portion;
a plurality of keys activatable from the bottom portion of the housing;
at least one key activatable from a first side portion of the housing; and
at least one key activatable from the second side portion of the housing.

21. The keyboard of claim 20, wherein the housing is transparent.

22. The keyboard of claim 20, wherein the plurality of keys activatable from the bottom portion of the housing are transparent, translucent, opaque or a combination thereof.

23. The keyboard of claim 20, further comprising a mechanism for indicating the character or function of the plurality of keys activatable from the bottom portion of the housing.

24. The keyboard of claim 23, wherein the mechanism for indicating the character or function of the plurality of keys comprises an icon or projected image.

25. The keyboard of claim 20, wherein the plurality of keys follow a QWERTY keyboard layout.

26. The keyboard of claim 20, wherein the plurality of keys are ergonomically positioned.
